(19) United States
(12) Patent Application Publication
(10) Pub. No.: US 2017/0025035 A1
(43) Pub. Date: Jan. 26, 2017

(54) METHOD OF GENERATING A THERAPEUTIC GAME FOR TREATING A PATIENT

(71) Applicant: Jennifer Nguyen, Melbourne (AU)

(72) Inventor: Jennifer Nguyen, Melbourne (AU)

(21) Appl. No.: 14/809,171

(22) Filed: Jul. 25, 2015

(51) Int. Cl. G09B 19/00; A63F 9/24

(52) U.S. Cl. CPC G09B 19/00; A63F 9/24

(57) ABSTRACT

Non-transient computer-readable storage having computer executable instructions stored thereon which, when executed by a computer, cause the computer to perform the following method steps for generating a therapeutic game for treating a patient (a) defining a set of clinical goals representing a set of therapeutic objectives for the patient; (b) generating one or more game episodes, where each one of said episodes includes play oriented game elements and/or clinically oriented game elements, wherein the play oriented game elements of each one of said game episodes is a motivational step that is a game activity for challenging and/or entertaining the patient so as to maintain his or her interest in playing the game; and wherein the clinically oriented game elements of each one of said game episodes are game steps that implement one of said clinical goals for the patient.

### CROSS-REFERENCE TO RELATED APPLICATIONS

The contents of Australian Provisional Patent Application No. 2013900336 filed in the name of Jennifer Nguyen on 2 Feb. 2013 is incorporated herein by way of reference.

### TECHNICAL FIELD OF THE INVENTION

The present invention relates to a method of generating a therapeutic game for treating a patient; a therapeutic game for treating a patient, and a system and method of medical treatment.

### BACKGROUND OF THE INVENTION

Existing therapeutic tools implemented as learning based interactive games attempt to engage the interest of subject users. However, the effectiveness of existing designs is heavily compromised by:

1. A lack of separation between clinical and game play elements,
2. A lack of separation between clinical and game play objectives,
3. A lack of separation between clinical and game play scoring mechanisms.

These failings result in:

1. Low engagement of the subject
2. Less effective clinical operation
3. Less effective or relevant clinical assessment outcomes.

For example, Super Duper Publications' Irregular Verbs Fun Deck application can elicit low engagement of the subject because the game does not indicate how far the subject has progressed, and when the game will finish. It also does not present the subject/patient with any motivational game play to encourage them to continue playing.

This application also demonstrates less effective clinical operation as it shows the subject/patient and clinician very simple scoring. It does not highlight specifically what the subject is experiencing difficulty with. Although the clinician can individually choose the target needs of the patient, this is not recorded. Therefore the clinical assessment outcomes become less effective or relevant.

It is generally desirable to overcome or ameliorate one or more of the above mentioned difficulties, or at least provide a useful alternative.

### BRIEF SUMMARY OF THE INVENTION

In accordance with one aspect of the invention, there is provided a non-transient computer-readable storage having computer executable instructions stored thereon which, when executed by a computer, cause the computer to perform the following method steps for generating a therapeutic game for treating a patient:
(a) defining a set of clinical goals representing a set of therapeutic objectives for the patient;
(b) generating one or more game episodes, where each one of said episodes includes play oriented game elements and/or clinically oriented game elements, wherein the play oriented game elements of each one of said game episodes is a motivational step that is a game activity for challenging and/or entertaining the patient so as to maintain his or her interest in playing the game; and wherein the clinically oriented game elements of each one of said game episodes are game steps that implement one of said clinical goals for the patient.

In accordance with the invention there is also provided a non-transient computer-readable storage having computer executable instructions stored thereon which, when executed by a computer, cause the computer to perform the steps of:
(a) generating data representing a graphical user interface for a therapeutic game for treating a patient, said game including:
   (i) a set of clinical goals representing as a set of therapeutic objectives for the patient;
   (ii) a series of game episodes, where each one of said episodes includes play oriented game elements and/or clinically oriented game elements, wherein the play oriented game elements of each one of said game episodes is a motivational step that is a game activity for challenging and/or entertaining the patient so as to maintain his or her interest in playing the game; and wherein the clinically oriented game elements of each one of said game episodes are game steps that implement one of said clinical goals for the patient,
(b) receiving data representing a patient response to each one of said play oriented game elements; and
(c) receiving data representing a patient response to each one of said clinically oriented game elements.

In accordance with the invention there is provided a method of medical treatment, including the step of configuring the above described game to suit needs of a patient.

In accordance with the invention there is also provided a method of medical treatment, including the step of playing the above described game.

In accordance with the invention there is also provided a system for medical treatment, said system comprising:
(a) a computer system; and
(b) a computer readable data storage medium, in communication with the computer system, comprising instructions which, when executed, cause the computer to perform the steps claimed in any one of claims 1 to 25.

In accordance with the invention there is also provided a system for medical treatment, said system comprising:
(a) a computer system; and
(b) a computer readable data storage medium, in communication with the computer system, comprising instructions which, when executed, cause the computer to perform the steps claimed in any one of claims 26 to 50.

Preferred embodiments of the invention advantageously resolve one or more of the above identified problems by intentionally separating and structuring components of the clinical operation of the system with respect to any game play elements into multiple related functional flows, activities, theme segments and assessment mechanisms without impacting the playing satisfaction of the user/player.

The present invention relates to tools which aim to build and extend a subject's capability and skills in a specific clinical area through a therapeutic tool implemented as a computer game framework. The invention integrates targeted clinical activities and accompanying scoring mechanisms with entertaining game play activities in a uniquely structured manner in order to maximise relevant clinical outcomes for players through enjoyment and engagement in what otherwise appears to them to be a normal gaming activity.

### BRIEF DESCRIPTION OF THE SEVERAL VIEWS OF THE DRAWING

Preferred embodiments of the present invention are hereafter described, by way of non-limiting example only, with reference to the accompanying drawings in which:

FIG. 1 is a schematic diagram of a therapeutic learning system;

FIG. 2 is a schematic diagram showing a computer system capable of implementing the system shown in FIG. 1;

FIG. 3a is a flow diagram showing steps performed by the system shown in FIG. 2;

FIG. 3b is a diagram of an interface generated by the system;

FIG. 4a is a flow diagram showing steps performed by the system shown in FIG. 2;

FIGS. 4b to 4d are diagrams of interfaces generated by the system;

FIG. 5a is a flow diagram showing steps performed by the system shown in FIG. 2;

FIG. 5b is a diagram of an interface generated by the system;

FIG. 6 is a block diagram describing the framework of the system shown in FIG. 2;

FIG. 7 shows two Game Episodes, each containing a single Motivational Step;

FIG. 8 shows two Game Episodes, each containing a single Game Step;

FIG. 9 shows the combination of both a Motivational Element type Functional Flow, and a Game Step type Functional Flow;

FIG. 10 shows a complete Game, starting with an introductory Plot Element, leading into a Game Episode;

FIG. 11 is a flow diagram showing steps performed by the system shown in FIG. 2;

FIG. 12 is a Multiple Scoring Scheme of the system Multiple Scoring Scheme; and

FIG. 13 shows additional Plot Elements inserted across the existing Motivational and Game Step Functional Flows.

### DETAILED DESCRIPTION OF PREFERRED EMBODIMENTS OF THE INVENTION

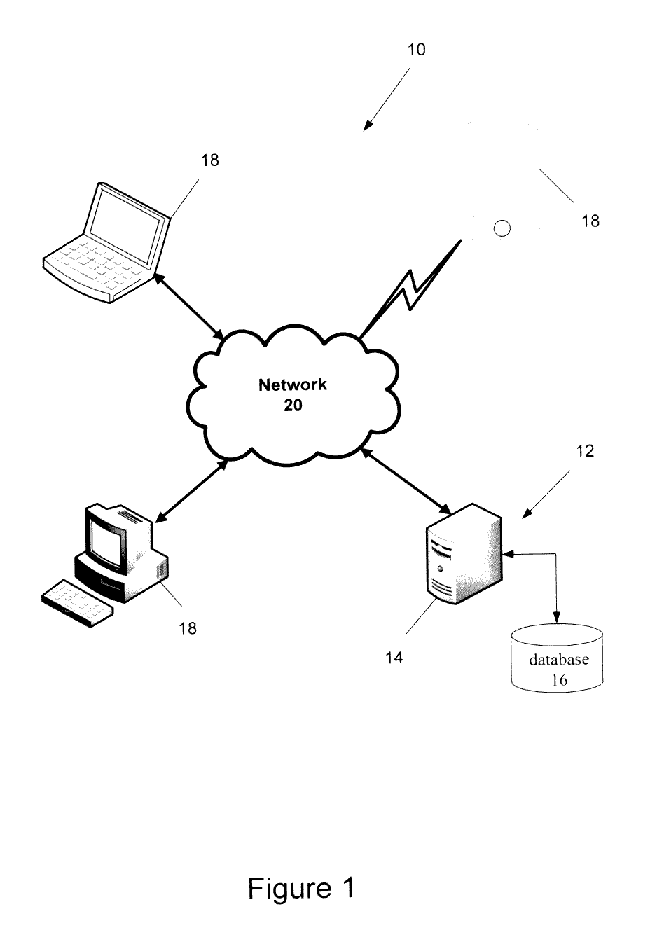

The therapeutic learning system 10 shown in FIG. 1 provides a framework upon which therapeutic games can be:
1. developed for specific targeted outcomes and stored in the system for later use;
2. configured by clinicians for use by specific patients;
3. played by patients over a series of episodes; and
4. dynamically tuned in accordance with the player's progress so as to retain the interest of the patient.

The term “patient” is used interchangeably with “player” throughout the specification.

The system 10 integrates targeted clinical activities with entertaining game play activities through the use of synchronised Functional Flows between the Story Line and Game Steps adaptively depending on the patient's needs and skills.

Configurable Game Themes also play an important contributing role because they allow the game to be packaged in such a way that it can appeal to and motivate players of various ages, sexes and interest areas to participate and consequently benefit from the clinical outcomes achieved via game play.

The Multiple Scoring Scheme aspect of this invention enables a Clinical score to be generated and made available to the supervising clinician, but be kept hidden from the player in order to maintain their engagement and motivation to continue to build the intended skill.

Despite there being very specific and structured tasks, there are also generic game play aspects such as signing up to retrieve scores, choosing level of difficulty, saving position and coming back to play later. These elements are present to increase the familiarity and appeal of the game structure to the player.

The system 10 seeks to achieve effective clinical therapy operation and relevant clinical outcomes for players through enjoyment and engagement in what appears to them to be a normal gaming activity.

The system 10 separates and structures components of games with respect to any game play elements into multiple related functional flows, activities, theme segments and assessment mechanisms without impacting the playing satisfaction of the user/player.

The system 10 provides clinical benefits in an active learning environment to patients. The system 10 provides a unique approach to solving the problem of developing therapeutic tools that are effective not only from a clinical perspective, but in addition are also challenging and entertaining from a game play perspective.

### The Computer System 12

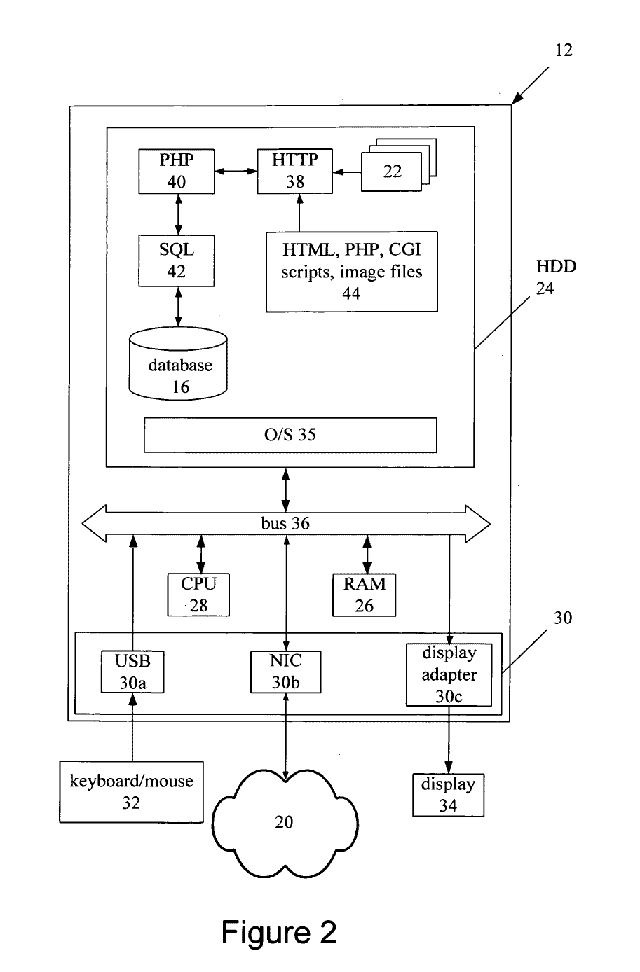

The system 10 is provided by a computer system 12 that includes a server 14 in communication with a database 16, as shown in FIG. 2. The computer system 12 is able to communicate with equipment 18 of members, or users, of the system 10 over a communications network 20 using standard communication protocols. The equipment 18 of the members can be a variety of communications devices such as personal computers; laptop computers, notepads, smart phones; hand held computers etc. The communications network 20 may include the Internet, telecommunications networks and/or local area networks.

The components of the computer system 12 can be configured in a variety of ways. The components can be implemented entirely by software to be executed on standard computer server hardware, which may comprise one hardware unit or different computer hardware units distributed over various locations, some of which may require the communications network 20 for communication. A number of the components or parts thereof may also be implemented by application specific integrated circuits (ASICs) or field programmable gate arrays.

In the example shown in FIG. 2, the computer system 12 is a commercially available server computer system based on a 32 bit or a 64 bit Intel architecture, and the processes and/or methods executed or performed by the computer system 12 are implemented in the form of programming instructions of one or more software components or modules 22 stored on non-volatile (e.g., hard disk) computer-readable storage 24 associated with the computer system 12. At least parts of the software modules 22 could alternatively be implemented as one or more dedicated hardware components, such as application-specific integrated circuits (ASICs) and/or field programmable gate arrays (FPGAs).

The computer system 12 includes at least one or more of the following standard, commercially available, computer components, all interconnected by a bus 35:

1. random access memory (RAM) 26;
2. at least one computer processor 28, and
3. external computer interfaces 30:
a. universal serial bus (USB) interfaces 30a (at least one of which is connected to one or more user-interface devices, such as a keyboard, a pointing device (e.g., a mouse 32 or touchpad),
b. a network interface connector (NIC) 30b which connects the computer system 12 to a data communications network, such as the Internet 20; and
c. a display adapter 30c, which is connected to a display device 34 such as a liquid-crystal display (LCD) panel device.

The computer system 12 includes a plurality of standard software modules, including:
1. an operating system (OS) 36 (e.g., Linux or Microsoft Windows);
2. web server software 38 (e.g., Apache, available at http://www.apache.org);
3. scripting language modules 40 (e.g., personal home page or PHP, available at http://www.php.net, or Microsoft ASP); and
4. structured query language (SQL) modules 42 (e.g., MySQL, available from http://www.mysql.com), which allow data to be stored in and retrieved/accessed from an SQL database 16.

Together, the web server 38, scripting language 40, and SQL modules 42 provide the computer system 12 with the general ability to allow users of the Internet 20 with standard computing devices 18 equipped with standard web browser software to access the computer system 12 and in particular to provide data to and receive data from the database 16. It will be understood by those skilled in the art that the specific functionality provided by the system 12 to such users is provided by scripts accessible by the web server 38, including the one or more software modules 22 implementing the processes performed by the computer system 12, and also any other scripts and supporting data 44, including markup language (e.g., HTML, XML) scripts, PHP (or ASP), and/or CGI scripts, image files, style sheets, and the like.

The boundaries between the modules and components in the software modules 22 are exemplary, and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, the operations may be combined or the functionality of the operations may be distributed in additional operations in accordance with the invention. Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

Each of the blocks of the flow diagrams of the processes of the computer system 12 may be executed by a module (of software modules 22) or a portion of a module. The processes may be embodied in a non-transient machine-readable and/or computer-readable medium for configuring a computer system to execute the method. The software modules may be stored within and/or transmitted to a computer system memory to configure the computer system to perform the functions of the module.

The computer system 12 normally processes information according to a program (a list of internally stored instructions such as a particular application program and/or an operating system) and produces resultant output information via input/output (I/O) devices 30. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

### User Access Types

### 1. User Access Type: System Administrator

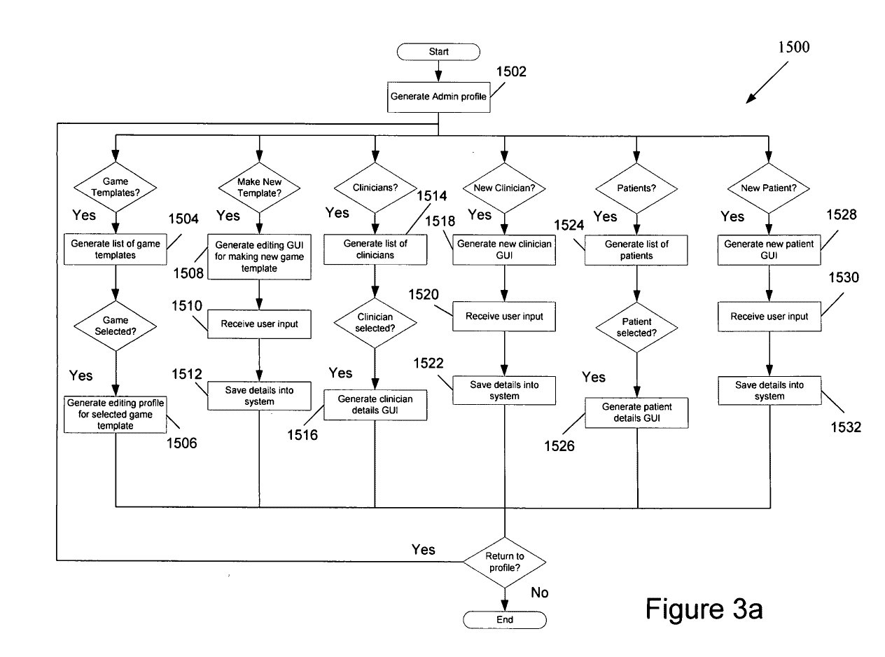

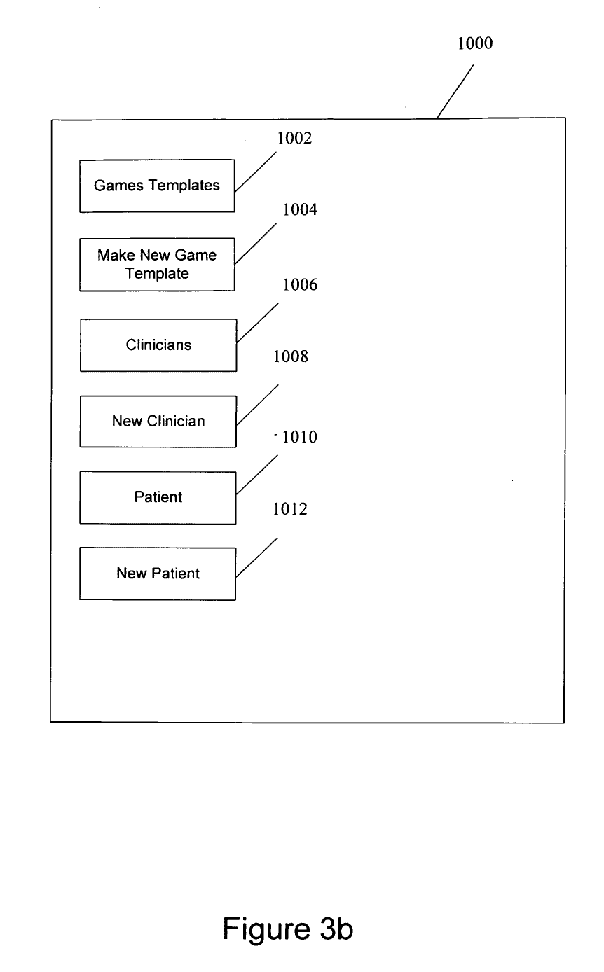

An administrator can use his or her device 18 to access the system 12 login page over the network 20. On receipt of an approved username and password, the system 12 performs the steps 1500 shown in FIG. 3a and generates, at step 1502, the profile page 1000 for the administrator shown in FIG. 3b. The profile page provides the clinician with the following function buttons:

a. Game Templates 1002;
b. Make New Game Template 1004;
c. Clinicians 1006;
d. New Clinician 1008;
e. Patients 1010; and
f. New Patient 1012.

On execution of the Game Templates function button 1002, the system 12 generates, at step 1504, a list of game templates that have been stored in the database 16. The administrator can select any one of the template shown in the list. On selection of one of the templates in the list, the system 12 will generate, at step 1506, an editing Graphical User Interface (not shown) for the selected template. The administrator can then edit the game template.

On execution of the Make New Game function button 1004, the system 12 generates, at step 1508, an editing Graphical User Interface (not shown) for facilitating the creation of a new game template. The system 12 receives, at step 1510, user input representing the new game template. On completion of the new game template, the system 12 saves, at step 1512, the template into data storage 16.

On execution of the Clinicians function button 1006, the system 12 generates, at step 1514, a list of clinicians that are members of the system 12. On selection of any one of the clinicians in the list, the system 12 generates, at step 1516, an interface showing the details of the clinician including:
i. full name;
ii. name of practice;
iii. address of practice;
iv. telephone number;
v. email address; and
vi. list of patients.

The administrator can add a new Clinician into the system 12 by executing the “New Clinician” function button 1008. On execution of the New Clinician function button 1008, the system generates, at step 1518, a New Clinician GUI which include the above fields for completion by the administrator. The system receives, at step 1520, the administrator's input and saves, at step 1522, the data into the data storage 16.

On execution of the Patients function button 1010, the system 12 generates, at step 1524, a list of patients that are members of the system 12. On selection of any one of the patients in the list, the system 12 generates, at step 1526, an interface showing the details of the patient including:
i. full name;
ii. address;
iii. telephone number;
iv. email address;
v. name of clinician; and
vi. gender.

On execution of the New Patient function button 1010, the system generates, at step 1528, a New Patient GUI which include the above fields for completion by the administrator. The system receives, at step 1530, the administrator's input and saves, at step 1532, the data into the data storage 16.

### 2. User Access Type: Clinician

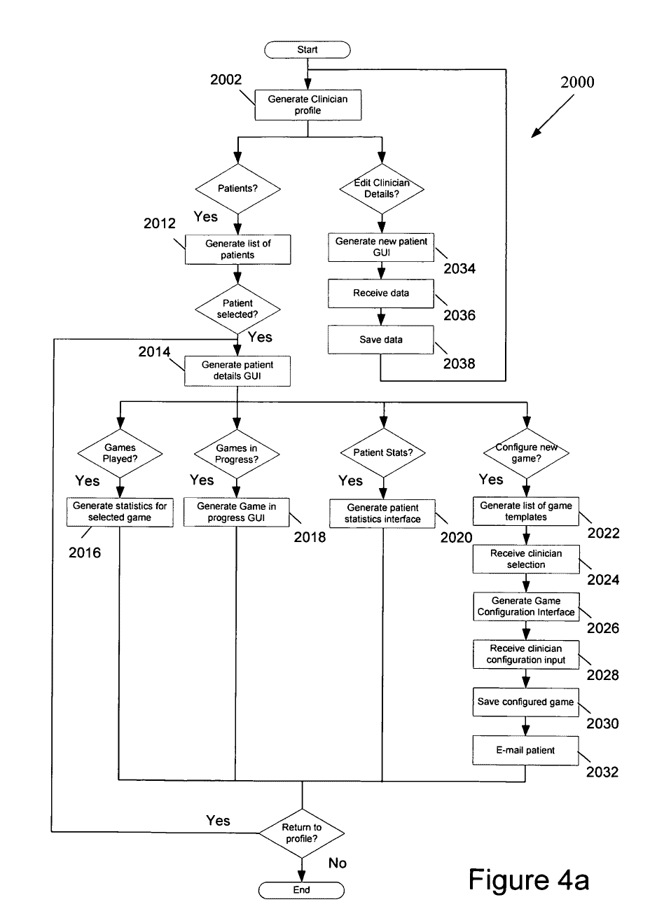

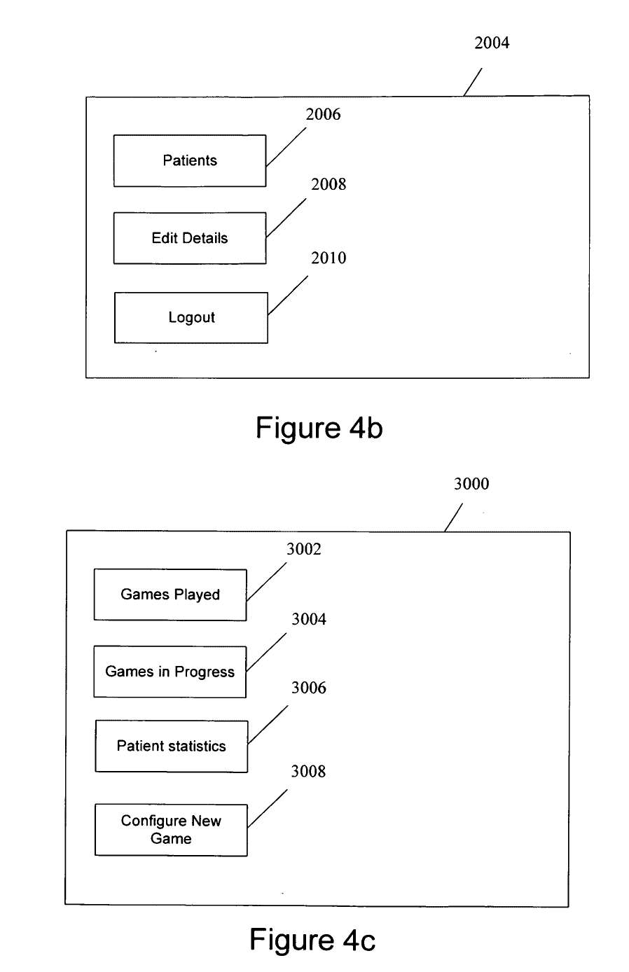

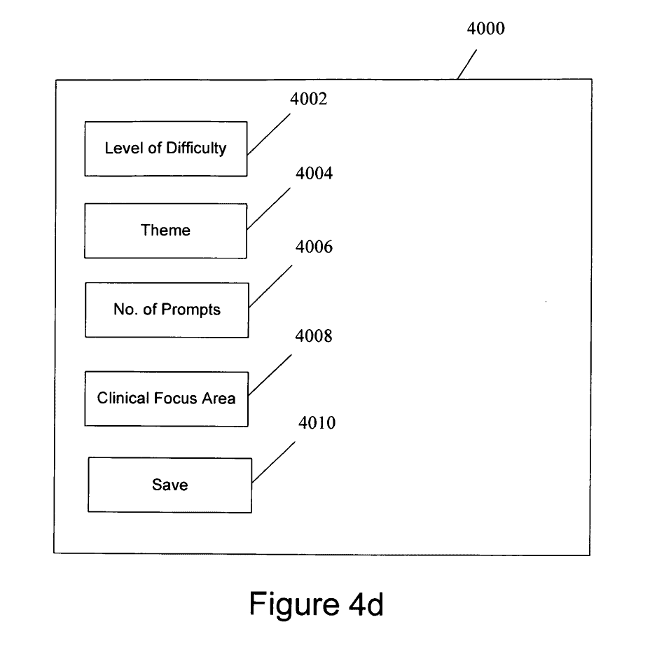

A clinician can use his or her device 18 to access the system 12 login page over the network 20. On receipt of an approved username and password, the system 12 performs the steps 2000 shown in FIG. 4a and generates, at step 2002, the clinician profile page 2004 shown in FIG. 4b. The profile page 2004 provides the clinician with the following function buttons:

a. Patient 2006;
b. Edit Clinician Details 2008; and
c. Logout 2010.

On execution of the Patient function button 2006, the system 12 generates, at step 2012, a list (not shown) of patients that are currently being serviced by the clinician. On selection of one of the patients in the list, the system 12 generates, at step 2014, the interface 3000 shown in FIG. 4c that includes the following details for the patient:

a. a list 3002 of the games played by the patient;
b. a list 3004 of games that are currently in progress;
c. Patient statistics 3006; and
d. Configure New Game 3008.

On selection of one of the games played in the list 3002, the system 12 generates, at step 2016, statistics associated with the game played by that patient. The system 12 returns the clinician back to the GUI for the patient 3000.

On selection of one of the games being played in the list 3004, the system 12 generates, at step 2018, statistics associated with the game played by that patient. The clinician can then dynamically monitor the progress of the patient as he or she works his or her way through the game. Advantageously, the system 12 allows the clinician to reconfigure the game being played so as to adapt the game to the patient's progress. For example, if the clinician notices that the patient is moving through the game steps too easily (for example, above 80% accuracy), then the clinician can increase the difficulty of the game by moving up to the next level. The system 12 returns the clinician back to the GUI for the patient 3000.

On execution of the Patient Statistics function button 3006, the system 12 generates, at step 2020, an interface showing all relevant data collected during game play for the patient. For example, the interface shows:

c. number of games played;
d. average scores for games played; and
e. history of scores for games played.

The system 12 returns the clinician back to the GUI for the patient 3000.

On execution of the Configure New Game function button 3008, the system 12 generates, at step 2022, a list (not shown) of game templates. On selection, at step 2024, of one of the game templates by the clinician, the system 12 generates, at step 2026, the Configuration Interface 4000 shown in FIG. 4d that includes the following fields:

f. Difficulty of Level 4002;
g. Theme 4004;
h. No. of Prompts 4006; and
i. Clinical Focus Area 4008.

The clinician can complete all of these fields, or a suitable selection, for the patient. The system 12 receives, at step 2028, this data. Once completed, the clinician executes the “Save” function button 4010 and system 12:
a. saves, at step 2030, the configured game for the patient in question;
b. sends, at step 2032, the patient an e-mail indicating that a new game is waiting to be played; and
c. returns the clinician to the patient interface 3000.

On execution of the Edit Clinician Details function button 2008, the system 12 generates, at step 2034 an editing GUI (not shown) with data fields including details about the clinician such as:
i. full name;
ii. name of practice;
iii. address of practice;
iv. telephone number;
v. email address; and
vi. list of patients.

The clinician can edit the details in any one of these fields. the system receives data, at step 2036, in that regard and saves, at step 2038, the new information into the database 16.

### 3. User Access Type: Patient

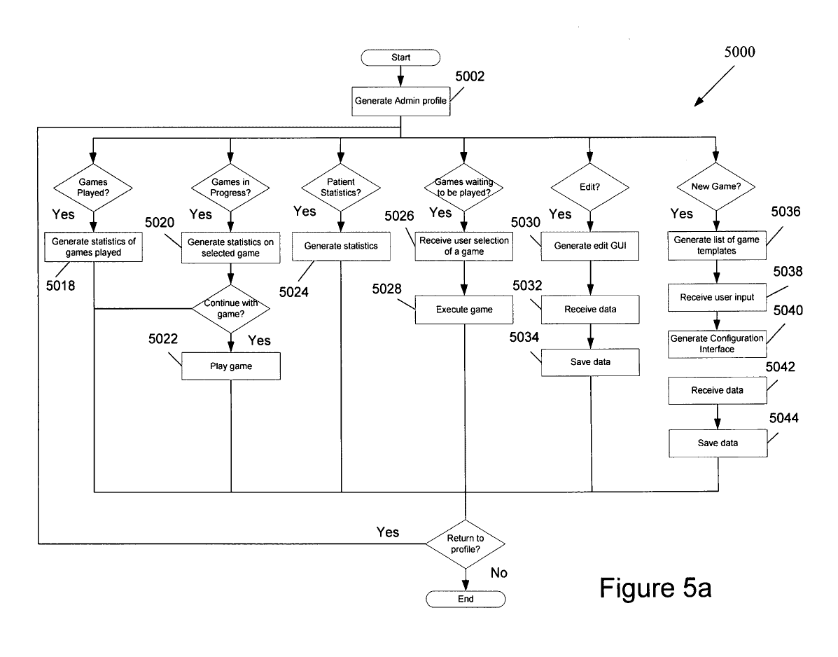

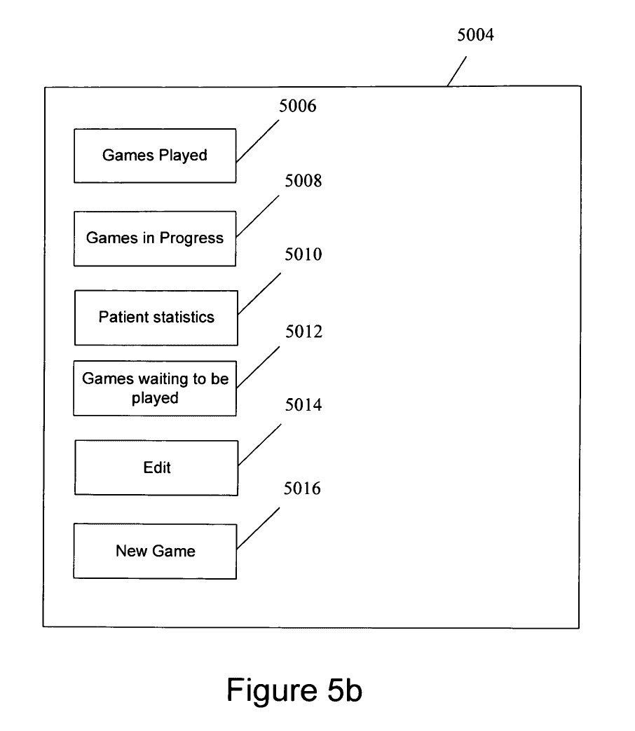

A patient can use his or her device 18 to access the system 12 login page over the network 20. On receipt of an approved username and password, the system 12 performs the steps 5000 shown in FIG. 5a and generates, at step 5002, the patient profile page 5004 shown in FIG. 5b which includes the following details for the patient:

a. a list 5006 of the games played by the patient;
b. a list 5008 of games that are currently in progress;
c. Patient statistics 5010;
d. a list of games 5012 waiting to be played;
e. an Edit function button 5014; and
f. New Game 5016.

On selection of one of the games played in the list 5006, the system 12 generates, at step 5018, statistics associated with the game played by that patient. As discussed in further details below, the statistics are centred around the game play aspects of games played as opposed to clinical aspects of games played.

On selection of one of the games being played in the list 5008, the system 12 generates, at step 5020, statistics associated with the game played by that patient and then offers the player the option to continue with the game. If the player chooses to continue with the game, then the system 12, at step 5022, executes the game for the player starting from the point at which the game was last saved.

On execution of the Patient Statistics function button 5010, the system 12 generates, at step 5024, an interface showing all relevant data collected during game play for the patient. For example, the interface shows:

a. number of games played;
b. average scores for games played; and
c. history of scores for games played.

As discussed in further details below, the statistics are centred around the game play aspects of games played as opposed to clinical aspects of games played.

The patient can use his or her user input device 18 to select a game from the list 5008 to be played. On selection of a game, the system 12 receives, at step 5026, the user selection and starts, at step 5028, the game for the patient. A more detailed explanation of this process is later described in this document.

Patient edit his or her user name, email address and date of birth, for example, by executing the “Edit” function button 5014. On execution of the Edit Details function button 5014, the system 12 generates, at step 5030 an editing GUI (not shown) with data fields including details about the clinician such as:
i. full name;
ii. date of birth
iii. address;
iv. telephone number;
v. email address;
vi. name of clinician; and
vii. gender.

The player can edit the details in any one of these fields. The system 12 receives this data at step 5032, and at step 5034 saves the new information into the database 16.

The player can start a new game under the supervision of a clinician, or a supervising adult, by executing the “New Game” function button 5016. In doing so, the system 12 generates, at step 5036, a list (not shown) of game templates. On selection, at step 5038, of one of the game templates by the patient, the system 12 generates, 5040, the Configuration Interface 4000 shown in FIG. 4c that includes the following fields:

a. Difficulty of Level 4002;
b. Theme 4004;
c. No. of Prompts 4006; and
d. Clinical Focus Area 4008.

The clinician, or the supervising adult, can complete, at step 5042, all of these fields, or a suitable selection, for the patient. Once completed, the clinician executed the “Save” function button 4010 and system 12:

a. saves, at step 5044, the configured game for the patient in question; and
b. returns the patient to the patient profile page 5000.

The patient profile page 5000 will include the newly configured game in the list 5008 of the games that are waiting to be played by the patient.

Patients can play games without being a member of the system 12. Patients who do not choose to sign up before playing are given an opportunity at the end of each game to ‘sign up’.

Patient membership details are retained with all of the players' scores. At any time player can request for all of the scores to be emailed to his or her account. Time and dates of when the games were started and completed are also included. Scores of therapeutic tasks include levels completed, number of tasks completed correctly, incorrectly, number of repetitions, number of repetitions scored correctly and number of repetitions scored incorrectly.

Player is able to save position and/or pause to play again at a later time, however the time start and finish will indicate that this has happened. Enabling the player to save position/pause and restart further encourages the player to continue playing the game without feeling that it is tedious.

### Framework for Therapeutic Games

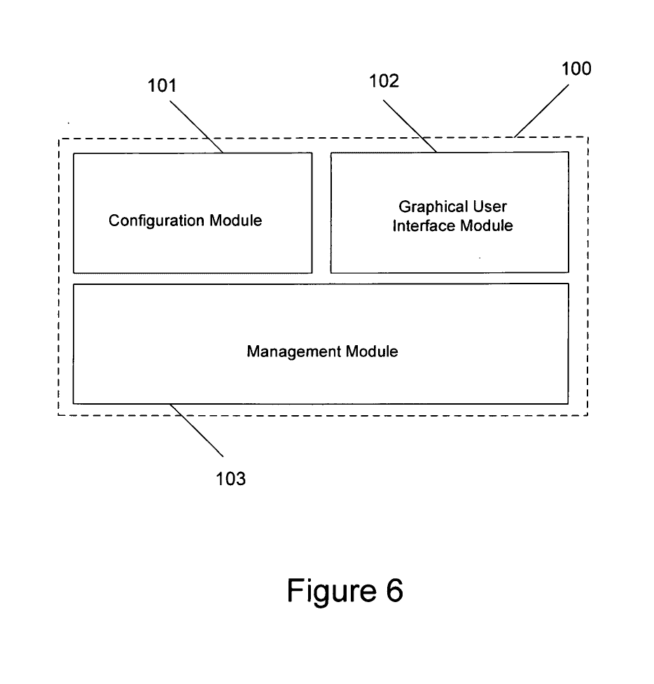

With reference to FIG. 6, the therapeutic learning system 10 is hereafter described with reference to the framework 100 having the following modules:
1. a configuration module 101 adapted to enable definition of therapeutic goals, game episodes, therapeutic game tasks, character based definitions and plot elements, structured across one or more functional flow paths;
2. a graphical user interface (GUI) module 102 adapted to enable player users to play through multiple series of such game episodes, under the impression or belief that normal games are being played; and
3. a management module 103 monitoring the game play progress of players and dynamically analysing/adapting presentation of game task steps of higher or lower difficulty, branching or merging of game plot and game task functional flow streams etc in order to optimise the therapeutic value for players while simultaneously maintaining player interest and enthusiasm.

The configuration module 101 stores all therapeutic and game related configuration information. It defines all therapeutic goals, game episodes, therapeutic game tasks, character based definitions and plot elements. The configuration module 101 can be implemented as a software module executable on a processor using any suitable software platform or architecture.

The information stored by the configuration module 101 is used dynamically during game play by the management module 103 and game play elements exposed through the graphical user interface module 102.

The graphical user interface module 102 is adapted to present all therapeutic goals, game episodes, therapeutic game tasks, character based definitions and plot elements to player users in a generalised game framework that seems to the player to be highly similar, or even indistinguishable, from any normal (non-therapeutic) game. The graphical user interface module 102 can also be implemented as a software module and can be implemented using the same or a different software language than the configuration module. Although in many embodiments a common software platform will be used to implement both the configuration module and graphical user interface, different languages may be used for different modules, provided the resulting compiled modules execute compatibly. A number of examples of tool implementations are outlined later in this document.

Embodiments of the framework 100 will also include business logic modules for implementing business logic for management functions within the management module 103. The management module 103 can also be implemented as a software module and can be implemented using the same or a different software language than the graphical user interface or configuration modules.

### Functional Flow/Functional Flow Synchronisation

Functional flows are sequences of game elements. Any given functional flow may contain either clinically oriented or game play oriented elements. Functional flows occur simultaneously and/or sequentially. They may be made visible to the player end user and/or the clinician depending on game system configuration, dynamic user performance and/or clinician tuning of game system configuration.

### Functional Flow Type—Storyline

A Storyline sequences one, or more Plot Elements, which will in turn be related to one or more Character Elements. The purpose of a Storyline is to engage the player with an entertaining, scripted thread that spans multiple Game Sessions. A storyline may extend across multiple game episodes, games, or games series. A storyline may be conveyed by animation segments, static images, video and/or text segments within the game. A Storyline may additionally be extended across media elements outside of the game structure, such as video, radio, movie, print media and electronic media elements. There may potentially be multiple Storyline options associated to any Game Step from which a single Storyline will be selected and presented based on player decision outcomes.

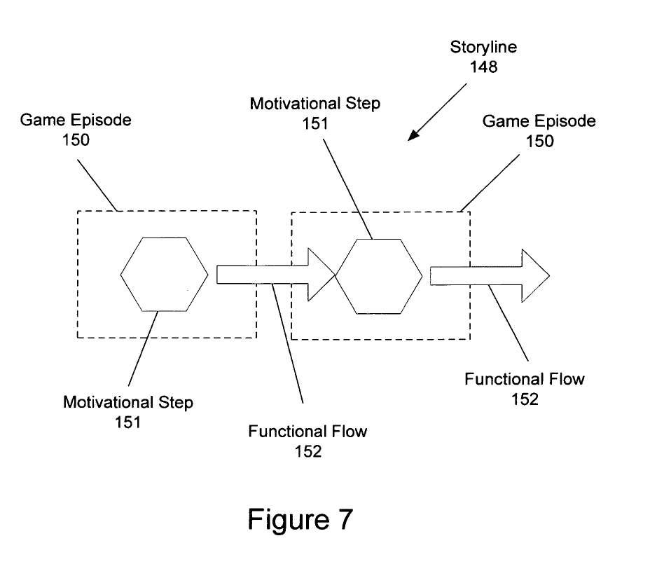

FIG. 7 shows a storyline 148 including two Game Episodes 150, each containing a single Motivational Step 151. The notion of there being a functional flow relevant to both Motivational Elements in the storyline 148 is shown as arrow elements 152.

### Functional Flow Type—Clinical Goals/Game Steps

Clinical Goals are established by expert clinicians as specific therapeutic objectives to be embedded in the context of a game. These are implemented as a series of game steps designed to exercise the child with regard to their ability in specific areas of therapy. Any particular series of game steps may be designed to lead a patient through challenges related to the area of therapy in a specific sequence in order to gradually develop the desired skill. The ordering of game steps in this way is regarded as being a functional flow having its own purpose and intended resolution.

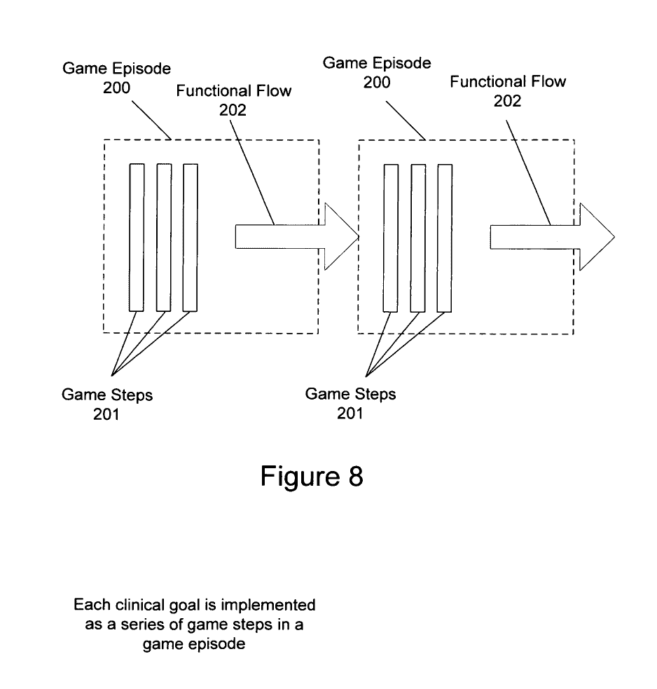

FIG. 8 shows two Game Episodes 200, each containing three Game Steps 201. The notion of there being a functional flow relevant to both Game Steps is shown as arrow elements 202.

### Synchronisation of Functional Flows

Functional flows may occur:
a. sequentially e.g., a storyline element appearing in advance of, or following a game step; and/or
b. simultaneously e.g., storyline element appearing in conjunction with, or appearing as a part of, presentation of a game step.

In a Functional Flow, the Storyline Elements and Game Steps may have a strong or weak association. There will usually always be some relevance between Storyline Elements and Game Steps at any given point in the game play. This will usually require that storyline path options are selected on the basis of game play step/task outcomes. This behaviour is true regardless of sequential or simultaneous functional flow relationship and the characteristics of any specific Storyline Element and Game Step involved.

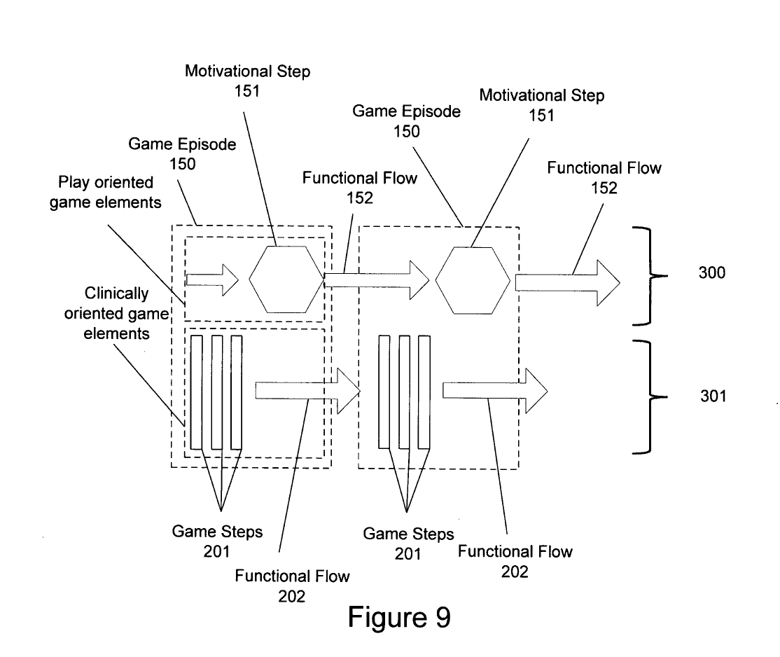

FIG. 9 shows the combination of a Motivational Element type Functional Flow, indicated as all elements in horizontal bracket 300 and a Game Step type Functional Flow indicated as all elements in horizontal bracket 301, synchronised in parallel with each other through a common series of Game Episodes.

### Adaptive Task Presentation

Game logic may be configured to make decisions dynamically during game play to present successive Game Tasks and Game Stages based on immediate and historical past player performance. This behaviour is called Adaptive Task Presentation. Adaptive Task Presentation logic may be configured to monitor one or more factors including:
player clinical performance
player game play performance.

The weighting assigned to clinical performance over game play performance may be controlled by the clinician or supervising person with relevance to the needs of the player. A player who is struggling with development, is just starting, or is suffering from attention span related issues may have their Adaptive Task Presentation profile configured to favour game play performance in order to maximise playing enjoyment until the child/player becomes sufficiently engaged such that their Adaptive Task Presentation profile can be weighted back towards clinical performance, without risking the motivation of the child/payer to continue playing the game.

The player/subject is engaged by a tool that uses a façade of engaging character, storyline and game play elements. At the same time, the tool produces therapeutic benefits for the player.

It is likely that Game Tasks and Game Stages sequenced dynamically by Adaptive Task Presentation logic should trigger presentation of other specific game elements, such as Plot and Character elements. In this respect Adaptive Task Presentation logic is acting in the overall context of the Functional Flow behaviour of any game where Adaptive Task Presentation logic is used, and may therefore be considered to be closely aligned to Functional Flow capability.

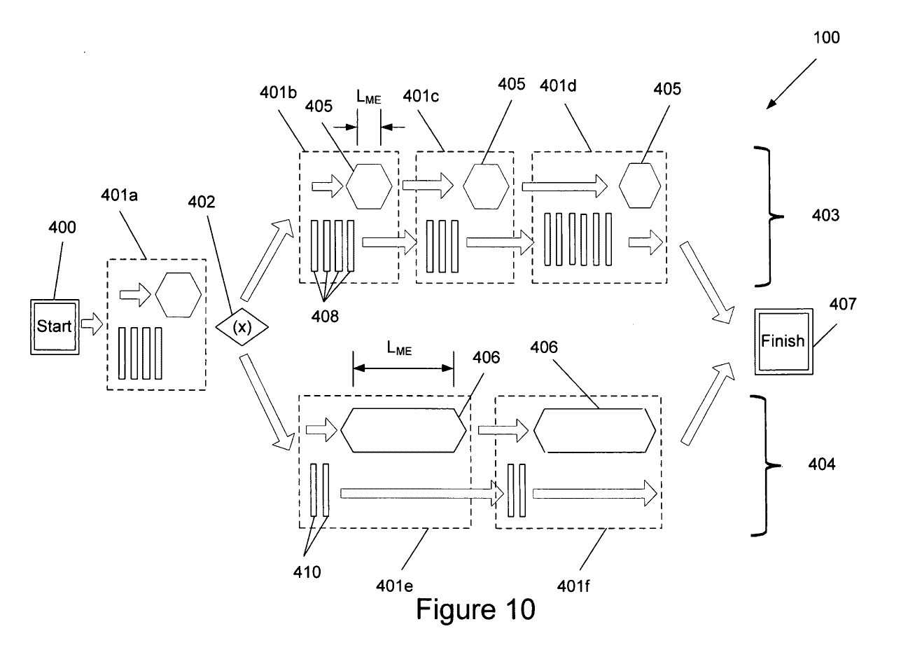

FIG. 10 shows a complete Game 100, starting with an introductory Storyline Plot Element 400, leading into a Game Episode 401a. Adaptive Task Presentation is depicted as making a decision 402 based on player performance during Game Episode 401a. A higher performing player will be taken through the upper set of Game Episodes as represented by elements in horizontal bracket 403. A low performing player will be taken through the lower set of Game Episodes as represented by elements in horizontal bracket 404.

It can be seen that the length, LME, of Motivational Elements 405 present in adaptive path 403 is shorter than the Motivational Elements 406 present in adaptive path 404, and that the number of Game Step items 408 in each Game Episode 401b, 401c, 401d is higher in adaptive path 403 than the number of Game Step items 410 in each Game Episode 401e, 401f in adaptive path 404. This has been configured based on the expectation that a low performing player will struggle to complete Game Steps in comparison to a high performing player, and is at risk therefore of losing interest in continuing with game play. By lengthening Motivational Step elements 406, it is expected that the interest of a low performing player can be retained more effectively, and that by reducing the number of Game Steps 410, the frustration associated with a lack of ability to complete the set game step tasks will be reduced.

Motivational steps are preferably constructed to be relatively easy to complete compared to game steps, and are constructed to be more relevant to the overall plot element flow in the game. This approach is based on an expectation that results can eventually be achieved with a low performing player by maintaining his or her interest such that they continue, albeit at a slow pace, rather than them disengaging completely. In contrast to this, a high performing player will feel more satisfaction based on their ability to complete Game Steps 408 successfully, and can therefore be sequenced through a higher number of Game Steps, with less need for lengthy Motivational Step 405 elements to maintain their engagement.

Once the designated number of Game Episodes has been completed via either adaptive path 403 or 404, the Game flow is shown merging back into a common Plot Element acting as the Game endpoint 407 which preferably includes presentation of game score values (see below for more detailed examples).

### Configurable Game Themes

A Game Theme is a specific packaging of Plot Elements, Character Elements and Game Step Elements. Multiple Game Themes may be implemented with respect to any single underlying clinical program.

Examples Game Themes may include:
Question and answer style Game Steps regarding a group of animal characters going to Church on Sunday.
A game requiring vehicle driving style Game Steps through a series of obstacles representing ‘good’ or ‘bad’ choices (e.g. running over a Granny or not) with robot style characters as drivers.
A game requiring movement of People type characters to visual markers representing differing choice propositions.

It will usually be desirable to support any particular Clinical Area across one or more Player Classes. A set of Clinical Goals structured within a Clinical Area may be implemented for multiple Player Classes using Game Themes relevant for each Player Class concerned.

In this way, the same underlying clinical program can made available in a way that is interesting and engaging to player groups of different sexes, ages and capability levels.

A Clinician or supervisor may choose to select which theme to use for any given player, or which themes a player may have access to choose from.

Game Themes would be configured to suit different therapeutic needs or functional difficulties, for example, simple/obvious movement based tasks may be used if the player has cognitive difficulties. Other types of therapeutic requirements may determine whether task 10 types employed are explicit, implicit, verbal, written or audible.

### Multiple Scoring Processes

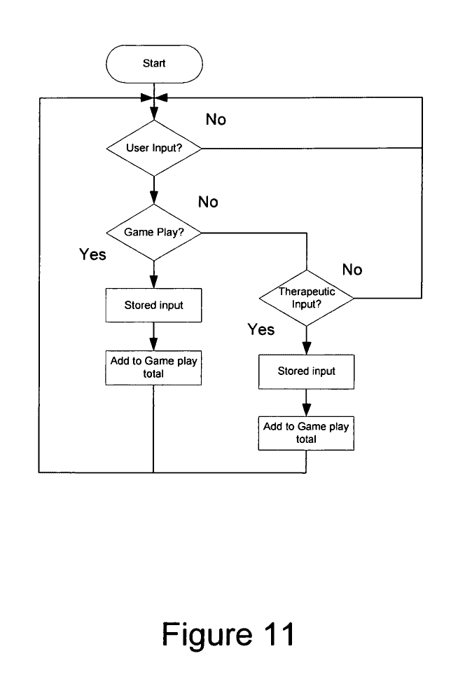

With reference to FIG. 8, during game play the system 100 will store detailed data regarding the player's execution of each task. Tasks may be structured to support scoring rules with respect to both therapeutic performance and also game play performance. A player/subject may think that they have completed a task relative to the storyline context, or on an even more simplistic basis such as aligning objects of similar colour etc. The associated game play scoring rules would typically represent a simple/direct interpretation of the result—‘did the player align the blocks or not’, or ‘was Frumpy The Clown going the right way to Town now’. Therapeutic scoring rules would normally take clinical criteria or factors into account, such as blocks being moved successfully towards other blocks of specific colour groupings or sizes, or a correct moral value judgement, for example whether ‘Frumpy is helping his friends by going that way’. The game 100 will tally game play scores for tasks across episodes, games and game series. As shown in FIG. 11, the game 100 will separately tally motivational and therapeutic scores in parallel for tasks across episodes, games and game series.

Depending on the age of the player and the nature of the player's personal or clinical context, the player may only be shown the motivational score. Otherwise access to therapeutic scores may require password access for the clinician/adult overseeing scores. The aim is for the player to continue playing the next games or episodes to practice their target goal without concern for their technical clinical performance. Therapeutic score will be analysed to allow the clinician to identify specific areas of performance or non-performance and to apply contingencies in terms of game configuration if required.

Once one episode is finished, the player will normally continue playing the next episode or game, as though they are playing any conventional game.

Prior to any interaction with the game system, the clinician will have assessed the clinical needs of the subject.

Prior to the subject beginning commencement of the game, the clinician will configure the game session by selecting one or more clinical focus areas relevant to the subject's needs. The clinician will enter a level of existing capability that the clinician believes the patient/subject possesses against each of the clinical focus areas selected in the game session, and also a target level of capability that the clinician believes is appropriate to attempt guiding the patient towards during game play.

Additionally, the clinician will select an appropriate game theme, based on the age, sex and perhaps interests of the subject.

The game system will store all details relating to clinical needs, selected clinical focus areas, existing capabilities and target capability levels, against the patient/subject's profile.

The patient/subject will then begin playing the game.

During the execution of the game, the game logic will capture and record:
all game step selections made by the player
all clinically based game step scores calculated by the game logic
all simple/game-play based game step scores calculated by the game logic
all clinical episode level scores as calculated by the game logic
all simple/game-play episode level scores as calculated by the game logic.

During game play the system will progressively consolidate the patient/subject's game step responses and produce clinical ranking values relevant to the clinical focus areas being managed during the game session. This information is a key input into the adaptive task presentation logic, which is executed upon the completion of each game step. Adaptive task presentation logic will compare these progressive clinical ranking values against the current existing and target capabilities as configured for the player, and will accordingly make decisions to alter functional flow during the game.

In conjunction with this activity, the system will also record:
all functional flow assessments and selections made by the game logic
game and episode completion status information (i.e. which steps & episodes were started, and which were completed).

Game play may continue through multiple episodes for as long as the player wishes, or until the game play reaches a major completion stage where clinician involvement is required to continue.

Once game play has finished, the system will:
summarise clinically based game step scores into episode and game level clinical scores
summarise simple/game-play based game step scores into episode and game level game step scores
categorise clinical scores against existing and target capabilities in terms of Fail/Pass/Exceed and by what factor (Standard deviation against generalised database?) against each clinical focus area.

### Alternative Scoring System

Another alternative scoring system can retain full use of distinct clinical steps/scoring and motivational steps/scoring, but use a different strategy within the associated adaptive task presentation logic. In this version of the system, a ratio of required correctly answered clinical steps to motivational steps may be configured, (e.g., 2:1—a total of 20 clinical steps and 10 motivational steps, where 2 consecutive clinical steps must be answered correctly). The game logic will not present the relevant motivational task(s) unless enough clinical steps have been answered to satisfy the configured clinical step to motivational step ratio (which may result in the player not having an opportunity to complete the thread of motivational steps within game). This scoring scheme can be employed and be beneficial for skill development with players who are (for example) low functioning, but who display higher levels of focus towards completing clinical game steps (which are less engaging than motivational game steps). The impact of the use of this altered adaptive task presentation logic is that the motivational score will perhaps become meaningless, at the expense of increased clinical effectiveness. The use of this scoring system would be at the discretion of the clinician, with respect to their assessment of patient/player needs and characteristics.

### Example Game

### Pronoun Birthday Party

A therapeutic game generated by the system 12 to teach the use of pronouns to children or those who experience difficulty using them within the English language. As the name suggests, the player will be learning about the use of Pronouns in the context of a Birthday Party. Pronoun Birthday Party's Clinical Focus Area is syntax, specifically focusing on the pronouns ‘he, she and they’.

The game contains two functional flows:

a. a therapeutic flow and
b. a motivational flow.

The motivational functional flow can be likened to a reward system.

The therapeutic functional flow emulates, but does not necessarily replace, speech therapy sessions. Learning can take place at a number of skill levels. The use of multimedia elements described in this game example as motivational game elements is given here purely as an example. There are numerous other ways player motivation can be addressed, including cognitive challenges, motor skill challenges, etc.

The supervising clinician can use equipment 18 to select an appropriate game level according to the player's current skills. For example, the game supports three difficulty levels. Unless a difficulty level is specifically chosen, the game will start from the easiest level and attempt to move towards to hardest. The difficulty level chosen for the first Episode is maintained when the player proceeds to the next Episode in order to ensure continuity unless the player succeeds in performing well enough for the game to adaptively change difficulty level, or as a result of intervention by the supervising clinician.

The clinician can also configure the following aspects of the game:
a. Text/instructions to appear with the verbal instructions played during the Clinical Focus Area Game Steps; and
b. Sound effects/verbal praise for correct and/or incorrect answers
   i. Frequency of sound effects/praise.

### Game Episode Structure of the Pronoun Birthday Game

The Pronoun Game is completed over three episodes. The start and end of each Episode is clearly stated via Storyline Plot Elements located at the beginning and end of the episode to indicate to the child where they are within the game. These Storyline Plot Elements, in conjunction with other Storyline Plot Elements situated within each episode, form a continuous Storyline Functional Flow from the beginning to the end of the whole Game. For example, at the end of the first episode Nigella is visible and she says:
“This is the end of the first episode. In the next episode you can continue to help me bake the cake for Fluffy. You also get to watch us prepare for the party! See you next time!”

The second episode would open with Nigella as being visible and saying “Welcome back! Are you ready to bake the cake now?”, therefore continuing the plot thread from the end of the first episode.

### Start of Episode One of the Pronoun Birthday Game

The start of Episode 1, and overall Story Line, is highlighted when the game is introduced within the first few opening lines and animated opening scene. A number of characters are introduced, including Nigella and Fluffy. Nigella says, “It's Fluffy's birthday today. I wonder if she needs help with anything?” When Nigella meets Fluffy, as the animation continues it is clear that after burning multiple cakes, Fluffy needs help with baking for the birthday party and therefore Nigella agrees to help her.

### Plot Elements of the Pronoun Birthday Game

Each character within the Pronoun Birthday game has its own Plot Element which is introduced by Nigella before those characters' scenes. For example:
For Mr Teddy, there is a separate scene where she will say, “I wonder what Mr Teddy bought Fluffy? Do you think he bought a jack in the box or a ball?” Then the next scene will reveal that Mr Teddy is wrapping up a jack in the box and that he experiences difficulty with successfully wrapping Fluffy's present.
Brownie's Plot Element involves Nigella initially introducing, “I wonder what Brownie is doing?” The next scene will show that Brownie is wrapping a maypole and the dilemmas that he encounters.
Fluffy's Plot Element is introduced with Nigella saying, “Let's see how Fluffy is preparing for the party!” The next scene reveals what difficulties Fluffy encounters at home when preparing for the party.

### Introduction of Clinical Focus Area

The Story Line transitions into a Clinical Focus Area with Nigella saying, “I need you to help me bake the cake. We will use the special words he, she, they. Let's practice them. This is a boy, you say . . . HE. Mr Teddy is a boy, you say . . . HE. Brownie is a boy, you say . . . HE. This is a girl, you say . . . SHE. Fluffy is a girl, you say . . . SHE. I am a girl, you say . . . SHE. When there are a lot of people, you say . . . THEY. Two people, you say . . . THEY. Three people, you say . . . THEY. Many people, you say . . . THEY. Ready? Let's begin!”. This statement would be given by Nigella in a friendly manner in order to ease the child towards and into performing Game Steps. Within the Game configuration, the clinician/adult may provide the player with an option to skip this introduction part if the clinician/adult feels that the player does not need to watch it.

### Transition to Game Steps

Following the introduction to the clinical focus area, a series of Game Steps are immediately presented next. This includes a mixture of:
a. steps that have been constructed to exercise the player's understanding of pronouns; and
b. motivational steps designed to maintain the player's emotional involvement.

At the start, tasks presented should preferably be achievable for the player to succeed in order to increase the chance of the player continuing with the game. Motivational Game Steps are included periodically between sequences of clinical Game Steps. Clinical Game Steps fall into three categories:
a. Category 1: Point to the correct picture
   i. A verbal instruction is given and the player is to touch the corresponding picture
b. Category 2: Drag and drop
   i. A verbal instruction is given and the player is to touch, drag and drop the object/picture to the corresponding pronoun
c. Category 3: Is it correct or wrong?
   i. A verbal instruction is given and the player is to indicate whether it matches with the picture by touching either the button ‘correct’ or ‘wrong’ button
d. Category 4: Fill in the sentence
   i. A verbal statement is given along with the corresponding sentence and illustration on the screen. The player is expected to fill in the empty space within the sentence on the screen with the appropriate pronoun by touching the corresponding box with the pronoun written on it.

Category 1 game steps tend to be the easiest form of question for a child to answer, as they only require the child to directly touch the picture representing the correct answer. Category 2 game steps tend to be more difficult than Category 1 game steps to complete, as they require the child to manipulate the correct object by dragging it across a geometric distance until it is over the correct corresponding answer, and then drop it. In the case of both Category 1 and Category 2 game steps, the answers presented provide an inherent visual prompt that can aid the child to determine the correct answer. Category 3 game steps tend to be the hardest because the child must listen to and analyse the question, and select the ‘correct’ or ‘wrong’ button without any additional visual clues. It should be noted that category type and difficulty level are not the same thing.

Each Difficulty Level may be made up of sentences that have different levels of grammatical complexity. This is seen in the use of grammatical markers in addition to the pronouns (e.g., She is wearing a hat AND sweeping the floor; He is sitting UNDER the tree). Examples of sentence complexity levels may include the following:
Simple Sentence Complexity Level: Subject+Verb+Object
Medium Sentence Complexity Level: Subject+verb+Preposition+Object
   Subject+Verb+Adjective+Object: For example: ‘She is sweeping the dirty floor’
   Use of coordinating conjunction ‘and’
Difficult Sentence Complexity Level: Subject+Verb+PresentParticiple+Object—For example: ‘She hit the running mouse’
   Subject+Verb+indirectObject+directObject—For example: ‘He gave the spoon to the dog’

The Difficulty Level chosen by the supervising clinician/adult will determine the mixture and sequence of Category 1, 2 and 3 game steps presented. In this game example, if the player begins at Difficulty Level 1 they will be presented first with a series of Category 1 game steps containing sentences at Medium Sentence complexity level. The verbal instruction may start with, “Point to . . . She has a party hat,” or, “He is drinking tea.”

Adaptive Task Presentation begins operating immediately as the player begins playing, within whatever sequence of game steps has been established initially according to the selected Difficulty Level. If the child performs nominally, Adaptive Task Presentation will have no impact on the game steps presented. In this example sequence, if the player completes “Point to . . . She has a party hat” game step successfully, another two Game Steps with a similar sentence structure appear before more complex sentences appear. This may include example game steps such as:
“Point to . . . He is sweeping the dirty floor” or
“Point to . . . They are sitting on chairs.”

If these next Category 1 game steps are also completed successfully with at least 70% accuracy, then the game step sequence may next include some Category 2 game steps, in order to provide a higher level of challenge to the child and maintain their engagement. However, if the Adaptive Task Presentation logic recognises that the child has not achieved a high enough success rate for the game steps encountered so far, then it may adapt the game step sequence to continue presentation of more Category 1 game steps, (e.g., an easier sentence will be given at Simple Sentence Complexity Level) in order to provide the child with more experience at this level, and to avoid presenting questions that may currently be beyond the ability of the child to answer. If this is the players' skill level, then this simple sentence complexity level will be maintained but the Category of game steps presented must change after 5 game steps. Once the player achieves 70% accuracy, game logic will increase the complexity level of sentences presented.

Alternatively, if the Adaptive Task Presentation logic recognises that the child is achieving a higher than expected rate of success, then it may begin by presenting more complex sentences structures from the Medium Sentence Complexity Level or even promoting the presentation of Category 2 game steps earlier than planned in the original sequence. The same behaviour for game step sequence and Adaptive Task Presentation continue through the transition from Category 2 to Category 3 game step questions, etc.

There will always be a configurable maximum number of Game Steps for each game step Category before a different Category of game steps is introduced. In parallel to this, sentence structures may still change according to the players' correct/incorrect answers. Once game steps from all three Categories are introduced in succession, they will then be presented at random.

In Episode 1, if the player chooses Difficulty Level 2 game steps of either Category 1 or 2 will initially appear. The player will always be presented with a clinical game step at simple sentence complexity level. If the player does not obtain 70% (or otherwise a set accuracy rate) accuracy in the first set of questions, set two will start with a single category. The player must obtain 70% accuracy by the second set of clinical tasks provided otherwise the game will stop and the player will be suggested to complete Difficulty Level 1. In Episode 2 players will be presented with game steps containing sentences at mid-level difficulty from either Categories 1 or 2. In Episode 3 players will be presented with game steps containing sentences at mid level difficulty from Categories from 1 to 3 at random.

If the player chooses Level 3 for either Episodes 1 to 3 they will start with any of the game step Categories at random, and be presented therefore with varying degrees of sentence complexity. If the player does not obtain 70% accuracy within the initial set of clinical tasks the game will stop and a lower level will be suggested.

Once the child has completed all game steps within Episode 1, Nigella will re-appear in another animated sequence, and say “Good work with mixing the cake and answering so many questions. Let's see what Brownie is doing!” The animated sequence will change into another scene showing the player Brownie preparing Fluffy's present. It also shows the difficulty he has with hiding it when someone rings the doorbell. At the end of the sequence Nigella reappears and says, “This is the end of the first episode. In the next episode you can continue to help me bake the cake for Fluffy.”

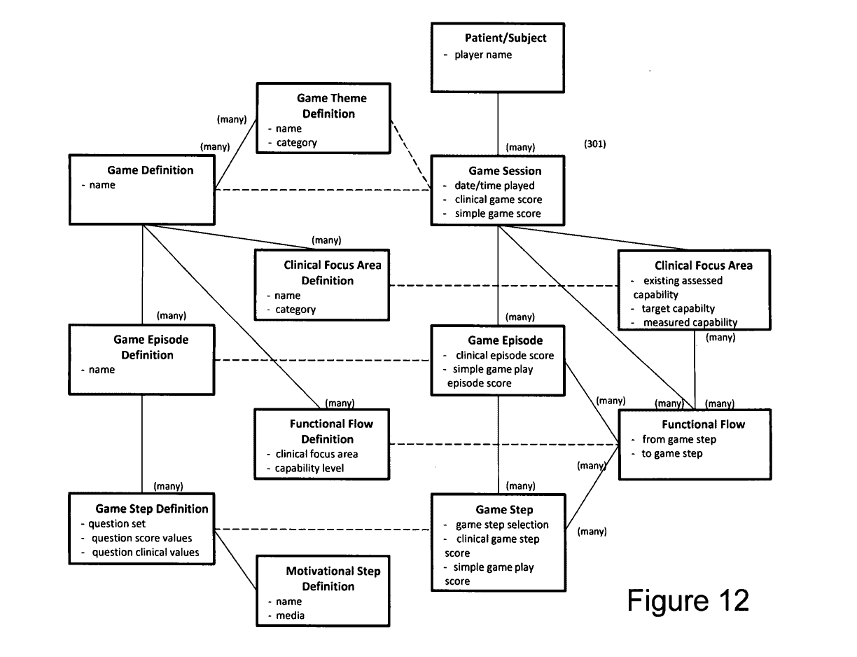

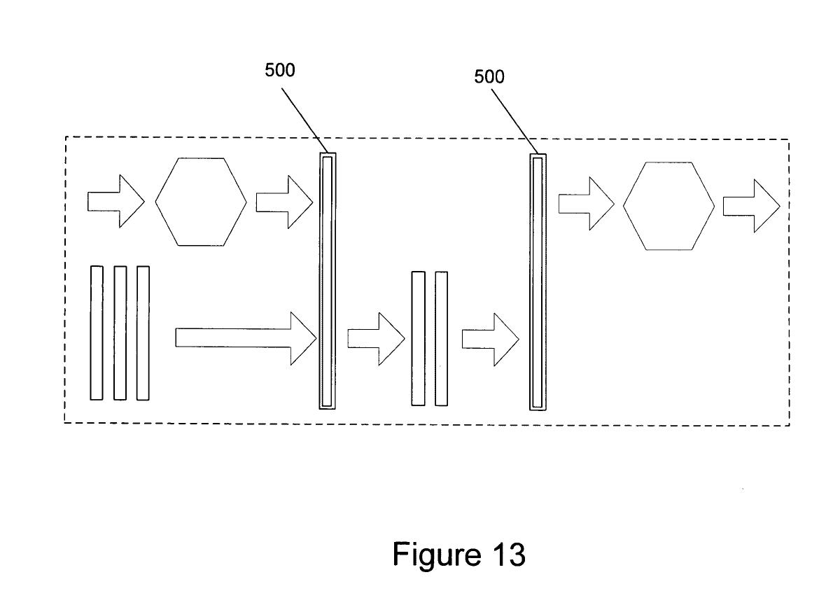

In Episode 1 at Level 1, a pre-defined number of clinical Game Steps will usually be followed by one or more Motivational Step(s). Even if the player fails at the clinical Game Steps, they still have the opportunity to complete the Motivational Steps. The Multiple Scoring Scheme, such as the one shown in FIG. 12, maintains clinical and motivational score values separately—note that clinical Game Steps can have both a clinical and motivational score. The first Motivational Step involves Nigella saying, “Help me turn on the oven.” The oven dial will appear. An arrow will also appear to indicate the direction of the turn. The red line will appear to indicate where to stop. The player is to touch and drag the dial in the corresponding direction. At the bottom of the screen there will be 5 black stars that turn yellow if the task is completed correctly. The player is given 10 seconds to complete the task. At the end of the 10 seconds the score will be given and then the page will transition back to the clinical Game Step. This pattern of clinical steps interspersed with motivational steps continues until the episode is finished.

### Episode Two Start

An opening panel for Episode 2 will then be presented, containing another animated sequence with Nigella exclaiming “Welcome back! Are you ready to bake the cake now?” She will also introduce a Plot Element involving Mr Teddy by asking, “But let's see what Mr Teddy bought Fluffy. Is it a ball or a jack-in-the-box?” The child may click the Start button in order to begin. Then an animated clip of Mr Teddy running into great difficulty wrapping the present because of Brownie interfering with the process will be shown. At the end of it Nigella reappears saying, “That's so funny! Okay, back to the cake!” The animated scene ends and the Clinical game step tasks commence.

Similarly as for Episode 1, a set of game and motivational steps relevant to the difficulty level selected will be presented to the child in sequence. Game logic will have recalled the Difficulty Level configuration, Adaptive Task Presentation history and the current Category item sequence planning from the child's stored profile. This will be used to continue the presentation of game steps of the appropriate Difficulty Level and Category for the child at this point in the game.

Depending on the child's progress, additional animated storyline plot elements may also be presented within the game step sequence of any Episode, in order to maintain the interest of the child. Depending on the attention span of the child, the regularity at which this is done can be pre-configured prior to game play. An example of this is shown in FIG. 13, where two additional Plot Elements 500 have been inserted across the existing motivational and game step functional flows.

If adaptive logic increases the number of game steps presented within any particular category, this may aid in keeping the involvement of the child at a higher level. Storyline elements included in this way would have originally been developed to be relevant to the Episode on a general basis such that any number of them could be inserted without seeming to upset the flow of what the characters are doing within the Episode(s), in this case baking a cake. For example, Nigella could appear in an animated panel saying “Come on then, let's get this cake baked”, or “Quick we need to get to Fluffy's party!” This is an example of the synchronization of functional flows within the game—if a child is experiencing difficulty playing the game, causing Adaptive Task Presentation logic to insert additional game steps, the interest of the child can be maintained via the insertion of these additional storyline elements, designed to support the current storyline plot context in which the child is seeing the characters involved in the game play. Similarly, the game system logic may insert more motivational steps relevant to the current storyline plot context, in addition to pre-established storyline elements, in order to maintain the engagement and variety for a child taking longer to get through the additional steps required for a child who is not performing well.

Once the child has completed all game steps within Episode 2, Nigella will re-appear in another animated sequence, and say “Good work with baking the cake and not getting your fingers burnt. Let's see what Fluffy is doing!” Another Plot Element will be shown with an animated sequence of Fluffy preparing for the party. The player is shown the dilemma that Fluffy has in being short. At the end of the animated sequence Nigella reappears, saying, “This is the end of the second episode. In the next episode we're going to have a big party, and you can help me to celebrate Fluffy's Birthday!”

### Episode Three Start

An animated storyline opening panel for Episode 3 will be presented with Nigella saying “Help me celebrate Fluffy's birthday party with cake and tea.” In the same way as for Episodes 1 and 2, Episode 3 will continue based on the child's current progress with game steps relevant to the Difficulty Level and current Adaptive Task Presentation history and Category item sequence. Within Episode 3 all the Plot Elements converge into the main Story Line, leading to the conclusion of the story.

Once all Clinical game step tasks have been completed Nigella will appear saying, “Great job baking the cake! Let's go to the party now!” The player's performance in the set motivational tasks will affect Nigella's comments about the cake. If the player has put too much sugar on the cake or set the temperature too high she would say, “The cake is a bit burnt”, or “It's a bit too sweet.” Then an animation showing the conclusion of the Storyline will appear which will represent various characters participating in the party. All the Story Elements converge as a part of the conclusion.

When this animation is completed all of the characters will say, “Come with us on more adventures! Next time we are going to the zoo!” The general idea is that they invite the players to participate in a new adventure with them.

Completion of Game: The scores attained for motivational tasks will then be presented to the player. The score for the Clinical tasks will be provided to the clinician/adult unless settings are changed so that the player is able to view the breakdown of their Clinical task scores. Areas of weakness, strengths and suggestions of what other Levels or other games to play in order to improve the player's skills will be highlighted in the feedback.

Contingencies for High Performing Players: There are additional contingencies to maintain the interest of and provide additional playing time to players who are performing with higher accuracy, and have therefore had their game play accelerated by Adaptive Task Presentation. For example if the child is accelerating in Episodes 1 and 2, at Level 1 and 2, completing tasks at 90% accuracy within half (or a set fraction) the given time frame, the difficulty of the tasks presented during later episodes may be increased. Also during later episodes, if the child's game step completion rate is still fast at 100% accuracy, the next difficulty level may be suggested.

If the child is accelerating in Episode 2 or 3 at Level 3, an extra Category 4 can for example be introduced to challenge the player—in order for this to happen the player must complete the tasks with 100% accuracy under half of the given time frame.

### Other Examples of the System 12

The system 12 has been above described by way of reference to a web application.

That is, for example, a centralised data server 14 having user interface functionality implemented as functional web pages published by one or more centralised web servers operating in conjunction with application layer logic implemented on one or more application servers accessing and manipulating data located on a data management system. However, the system 12 could, alternatively, be implemented according to a number of system architecture scenarios, including but not limited to:
1. Client Server: a centralised data server stores data potentially belonging to multiple users and ensures security partitioning is enforced between all Users in compliance with defined access control rules. User interface functionality is implemented as a client application module, or set of modules, that is installed and run locally on the User's computer or computing device. Delivery of client application modules may occur statically (such as via a manual installation process), on an assisted basis (such as via an online application store/shop, or software update process), or on a fully automated basis, such as via transparent delivery via web pages or some other localised application runtime host environment or application.
2. Offline/Disconnected: the application and data associated with any particular User are both located on a local computing device in the possession of that specific User. The User may periodically connect the device to a centralised server via a network connection and perform a bi-directional synchronisation of both changes made locally by the User, and changes made by other Users and stored centrally.
3. Local: the application and data associated with the implementation are both stored locally in the same local computing device, and can operate completely independently with respect to any centralised server implementation.

Each architectural scenario may be implemented using one or more specific technology implementations.

Examples of these are:
1. Centralised data server:
1.1. Proprietary Relational Database Management System (RDBMS) products such as: Oracle, SQL Server, DB/2
1.2. No SQL/Object Oriented Database Management System/Object Database products, such as: Objectivity/DB, Versant, Berkeley DB
2. Centralised web application server:
2.1. Java Web Application Server: Tomcat (application logic developed in Java)
2.2. Enterprise Java Server: WebSphere Application Server, Oracle Internet Application Server, JBoss (application logic developed in Java)
2.3. Microsoft IIS (application logic developed in .Net compatible languages—there are numerous, including C# and VB.NET)
2.4. Web servers compatible with other scripting languages such as Python, Ruby On Rails, etc
2.5. Web servers compatible with legacy languages including COBOL, FORTRAN
2.6. Web pages including dynamic content built using Javascript and/or other ECMA compatible languages
2.7. Web pages including dynamic content built using Java Standard Edition (J2SE)
2.8. Web pages including dynamic content built using Adobe Flash
2.9. Web pages including dynamic content built using HTML5
2.10. Web pages including dynamic content built using Microsoft ActiveX
3. For ‘client application module’ the following languages may be used to build:
3.1. Java Platform Standard Edition—J2SE
3.2. Java Platform Micro Edition—J2ME
3.3. C, C++, Objective C
3.4. Net compatible languages—there are numerous, including C# and VB.NET
3.5. Javascript and/or other ECMA compatible languages
3.6. HTML5
3.7. Adobe AIR
3.8. Other sandboxing technologies, including Google Native Client
4. For ‘local computing device’:
4.1. General purpose computer server or workstation:
4.1.1. Note: example CPU architectures/manufacturers include Intel, AMD, Alpha, Power, ARM etc. Example Operating Systems include Windows family, Apple OS/X family, Unix implementations, Linux implementations,
4.2. Tablet, Phone, Music Player, Book Reader, Personal Information Manager,
4.2.1. Note: example CPU architectures/manufacturers include ARM, TI OMAP, Intel Atom, AMD, Alpha, Power, etc.
4.2.2. Note: example Operating Systems include Windows family, Apple OS/X family, Unix implementations, Linux implementations,
4.3. Game Consoles,
4.4. Visualisation Systems

Many modifications will be apparent to those skilled in the art without departing from the scope of the present invention.

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that the prior art forms part of the common general knowledge in Australia.

### DEFINITIONS

This section describes foundational elements upon which the more complex aspects of this invention are based:

CLINICAL FOCUS AREA: A specific type of clinical problem. Examples include: Autism, Stuttering, Articulation, Lisping, Language.

CLINICAL GOAL: A specific clinical capability to exercise within a specific Clinical Focus Area. Any Clinical Goal will have a desired/expected performance range to be achieved associated with it. For example, the following Clinical Goals may be defined under the Clinical Focus Area of Lisping: sound in isolation, syllable level, word level, sentence level. Each of these four goals would have specific performance criteria associated with them, such as ‘70% accuracy’.

CHARACTER ELEMENT: A characterisation, usually fictional, created for use within the game/learning system structure. Characterisations may be developed as animated sequences, cartoons or by using filmed sequences of real actors. Characterisations will usually include a stylised voice and accent. Characterisations will usually include specific personal character aspects to impart specific desired traits such as compassion, temper, humour, credibility or authority, etc.

GAME STEP: A Game Step (also referred to as a game task) is a specific action to be completed by the player presented within a game. Game Steps are constructed to effect a specific Clinical Goal or Goals. Game Steps may be constructed in any manner as can be supported within existing or future game architectures.

Examples of Game Steps may include:
hit object into a receptacle or target,
change the path of movement for an object(s) or character(s),
shoot an object(s) or character(s),
select an object(s) or character(s),
move an object(s) or character(s),
find some an object(s) or character(s),
answer a question.

Instructions for Game Steps can be given in explicit, implicit, verbal, or written form, and/or through sound. Specific game implementations will tend to implement a limited number of Game Step types, such that a distinctive playing mode is embodied within the game. Game Steps may either be clinical in focus, motivational/fun oriented, or a combination of both clinical and motivationally oriented.

MOTIVATIONAL STEP: A Motivational Step is a game activity designed to be challenging and/or entertaining for the player, principally to maintain their interest in playing the Game. A Motivational Step does not have any specific Clinical Goal associated with it.

STORY LINE: A Story Line describes a complete story plot, including one or more Plot Elements.

PLOT ELEMENT: A script segment occurring somewhere within a single Story Line. There may be multiple Plot Elements per Story Line. For example, ‘In preparation for a party each character is preparing their own food and presents’.

GAME STAGE: A Game Stage groups a set of related Game Steps (tasks).

GAME: A Game contains a sequence of related Game Episodes.

GAME SESSION: A Game Session describes a single sitting during which a player uses a game. A Game Session may cover a partial Game Episode, multiple Game Episodes or even multiple Games.

1. Non-transient computer-readable storage having computer executable instructions stored thereon which, when executed by a computer, cause the computer to perform the following method steps for generating a therapeutic game for treating a patient:
(a) defining a set of clinical goals representing a set of therapeutic objectives for the patient;
(b) generating one or more game episodes, where each one of said episodes includes play oriented game elements and/or clinically oriented game elements, wherein the play oriented game elements of each one of said game episodes is a motivational step that is a game activity for challenging and/or entertaining the patient so as to maintain his or her interest in playing the game; and wherein the clinically oriented game elements of each one of said game episodes are game steps that implement one of said clinical goals for the patient.

2. The method of claim 1, wherein play oriented game elements of adjacent game episodes have a common functional flow.

3. The method of claim 1 or claim 2, wherein the play oriented game elements include a common storyline.

4. The method of claim 3, wherein the storyline spans multiple game sessions.

5. The method of claim 3 or claim 4, wherein the storyline includes sequences one or more plot elements, which are in turn related to one or more character elements.

6. The method of any one of claims 3 to 5, wherein the storyline extends across multiple game episodes, games, or games series.

7. The method of any one of claims 3 to 6, wherein the storyline is conveyed by at least one of animation segments; static images; video and text segments within the game.

8. The method of any one of claims 1 to 7, wherein each series of game steps leads a patient through challenges related to the area of therapy in a specific sequence in order to gradually develop the desired skill.

9. The method of claim 8, wherein the ordering of game steps in each series of game steps is a functional flow having its own purpose and intended resolution.

10. The method of any one of claims 1 to 9, wherein for one or more of said episodes, the play oriented game elements occur sequentially with the clinically oriented game steps.

11. The method of any one of claims 1 to 10, wherein for one or more of said episodes, the play oriented game elements occur simultaneously with clinically oriented game steps.

12. The method of any one of claims 1 to 11, wherein each one of said clinical goals has an associated performance range to be achieved by the patient.

13. The method of claim 12, including the steps of:
(a) receiving data representing a user response to a clinically oriented game element; and
(b) storing said data representing a user response to said clinically oriented game element in computer readable storage.

14. The method of claim 13, including the step of adding the data representing a user response to the clinically oriented game element to a total for the game.

15. The method of any one of claims 12 to 14, wherein each play oriented game element has an associated performance range to be achieved by the patient.

16. The method of claim 15, including the steps of:
(a) receiving data representing a user response to a play oriented game element; and
(b) storing said data representing a user response to a play oriented game element in computer readable storage.

17. The method of claim 16, including the step of adding the data representing a user response to the play oriented game element to a play oriented score for the game.

18. The method of claim 17, including the step of displaying the play oriented score for the game on a visual display unit for viewing by the patient.

19. The method of any one of claims 12 to 18, including the steps of:
(a) comparing the data representing responses to the games steps performed by the patient with a set of target answers;
(b) if the responses to the game steps are falling behind the target answers, then increasing the play oriented game elements of each episode and decreasing the clinically oriented game elements; and
(c) if the responses to the game steps are meeting the target answers, then decreasing the play oriented game elements of each episode and increasing the clinically oriented game elements.

20. The method claimed in claim 19, wherein a weighting is assigned to each one of said clinically oriented game elements to suit the specific treatment for the patient.

21. The method claimed in claim 19 or claim 20, wherein a patient who is struggling with development, is just starting, or is suffering from attention span related issues can have his or her game configured to favour game play performance in order to maximise playing enjoyment until the patient becomes sufficiently engaged in the treatment change weighting back towards clinical performance.

22. The method claimed in any one of claims 19 to 21, wherein the step of comparing is performed by a clinician reviewing the responses.

23. The method claimed in claim 22, wherein the step of comparing is performed by the computer reviewing the responses.

24. The method claimed in any one of claims 1 to 23, wherein each one of the game steps include one of:
hit object into a receptacle or target,
change the path of movement for an object(s) or character(s),
shoot an object(s) or character(s),
select an object(s) or character(s),
move an object(s) or character(s),
find an/some object(s) or character(s),
answer a question.

25. The method of any one of claims 1 to 23, wherein instructions for game steps are given in one of explicit, implicit, verbal, or written form, and/or through sound.

26. Non-transient computer-readable storage having computer executable instructions stored thereon which, when executed by a computer, cause the computer to perform the steps of:
(a) generating data representing a graphical user interface for a therapeutic game for treating a patient, said game including:
(i) a set of clinical goals representing as a set of therapeutic objectives for the patient;
(ii) a series of game episodes, where each one of said episodes includes play oriented game elements and/or clinically oriented game elements, wherein the play oriented game elements of each one of said game episodes is a motivational step that is a game activity for challenging and/or entertaining the patient so as to maintain his or her interest in playing the game; and wherein the clinically oriented game elements of each one of said game episodes are game steps that implement one of said clinical goals for the patient,
(b) receiving data representing a patient response to each one of said play oriented game elements; and
(c) receiving data representing a patient response to each one of said clinically oriented game elements.

27. The method of claim 26, wherein play oriented game elements of adjacent game episodes have a common functional flow.

28. The method of claim 26 or claim 27, wherein the play oriented game elements include a common storyline.

29. The method of claim 28, wherein the storyline spans multiple game sessions.

30. The method of claim 28 or claim 29, wherein the storyline includes sequences one or more plot elements, which are in turn related to one or more character elements.

31. The method of any one of claims 28 to 30, wherein the storyline extends across multiple game episodes, games, or games series.

32. The method of any one of claims 28 to 31, wherein the storyline is conveyed by at least one of animation segments; static images; video and text segments within the game.

32. The method of any one of claims 26 to 32, wherein each series of game steps leads a patient through challenges related to the area of therapy in a specific sequence in order to gradually develop the desired skill.

33. The method of claim 33, wherein the ordering of game steps in each series of game steps is a functional flow having its own purpose and intended resolution.

33. The method of any one of claims 26 to 34, wherein for one or more of said episodes, the play oriented game elements occur sequentially with the clinically oriented game steps.

34. The method of any one of claims 26 to 35, wherein for one or more of said episodes, the play oriented game elements occur simultaneously with the clinically oriented game steps.

34. The method of claim 36, including the step of storing said data representing a patient response to each one of said clinically oriented game elements in computer readable storage.

35. The method of claim 37, including the step of adding the data representing a patient response to each one of said clinically oriented game elements to a clinical total for the game.

36. The method of claim 37 or claim 38, including the step of storing said data representing a patient response to each one of said play oriented game elements in computer readable storage.

37. The method of claim 39, including the step of adding the data representing a patient response to each one of said play oriented game elements to a play total for the game.

40. The method of claim 40, including the step of displaying the play oriented score for the game on the visual display unit for viewing by the patient.

41. The method of any one of claims 37 to 41, wherein each one of said clinical goals has an associated target answer.

43. The method of claim 42, including the steps of
(a) comparing the data representing patient responses to each one of the clinically oriented game elements with corresponding target answers;
(b) if the patient responses to are outside the performance range, then changing the game episodes to increase the play oriented game elements of each episode and/or decrease the clinically oriented game elements.

44. The method of claim 42, including the steps of:
(a) comparing the data representing patient responses to each one of the clinically oriented game elements with corresponding target answers;
(b) if the patient responses to are inside the performance range, then changing the game episodes to decrease the play oriented game elements of each episode and/or increase the clinically oriented game elements.

45. The method claimed in any one of claims 42 to 44, wherein a weighting is assigned to each one of said clinically oriented game elements to suit the specific treatment for the patient.

46. The method claimed in any one of claims 43 to 45, wherein a patient who is struggling with development, is just starting, or is suffering from attention span related issues can have his or her game configured to favour game play performance in order to maximise playing enjoyment until the patient becomes sufficiently engaged in the treatment change weighting back towards clinical performance.

47. The method claimed in any one of claims 43 to 46, wherein the step of comparing is performed by a clinician reviewing the responses.

48. The method claimed in any one of claims 43 to 46, wherein the step of comparing is performed by the computer reviewing the responses.

49. The method claimed in any one of claims 26 to 48, wherein each one of the game steps include one of:
hit object into a receptacle or target,
change the path of movement for an object(s) or character(s),
shoot an object(s) or character(s),
select an object(s) or character(s),
move an object(s) or character(s),
find some an object(s) or character(s),
answer a question.

50. The method of any one of claims 26 to 49, wherein instructions for game steps are given in one of explicit, implicit, verbal, or written form, and/or through sound.

51. A method of medical treatment, including the step of configuring a game as claimed in any one of claims 26 to 50 to suit needs of a patient.

52. A method of medical treatment, including the step of administering a game as claimed in any one of claims 26 to 50 to a patient.

53. A system for medical treatment, said system comprising:
(a) a computer system; and
(b) a computer readable data storage medium, in communication with the computer system, comprising instructions which, when executed, cause the computer to perform the steps claimed in any one of claims 1 to 25.

54. A system for medical treatment, said system comprising:
(a) a computer system; and
(b) a computer readable data storage medium, in communication with the computer system, comprising instructions which, when executed, cause the computer to perform the steps claimed in any one of claims 26 to 50.
